(19) United States
(12) Patent Application Publication
(10) Pub. No.: US 2025/0199552 A1
(43) Pub. Date: Jun. 19, 2025

(54) GAS REGULATOR

(71) Applicant: PIETRO FIORENTINI S.p.A., Arcugnano (VI) (IT)

(72) Inventor: Mario Pietro NARDI, Arcugnano (VI) (IT)

(73) Assignee: PIETRO FIORENTINI S.p.A., Arcugnano (VI) (IT)

(21) Appl. No.: 18/953,135

(22) Filed: Nov. 20, 2024

(30) Foreign Application Priority Data
Dec. 18, 2023 (IT) 102023000027054

(51) Int. Cl. G05D 16/10

(52) U.S. Cl. CPC G05D 16/107

(57) ABSTRACT

Regulator for a gas control apparatus, for installation in a gas transportation and/or distribution network, includes a structure with a gas inlet and a gas outlet. The regulator includes, inside the structure: an upstream zone that is fluidly connected to the inlet, a downstream zone that is fluidly connected to the outlet, a passage opening interposed between the upstream zone and the downstream zone, a shutter movable within the downstream zone for closing and/or obstructing the passage opening, said shutter comprises a first face facing towards the downstream zone and a second face, opposite to the first face, facing towards the passage opening, and means for the controlled movement of the movable shutter.

### CROSS-REFERENCE TO RELATED APPLICATIONS

This application claims benefit of Italian Patent Application No. 102023000027054, filed Dec. 18, 2023, the entire contents of which are incorporated by reference herein as if fully set forth.

### TECHNICAL FIELD

The present invention concerns a regulator to be used in an apparatus for control gas pressure, and in particular of the type suitable for use and installation in plants and/or networks for the transport and/or distribution of gas, such as natural gas and/or also gases produced in a decentralized manner, such as biomethane and/or hydrogen.

### BACKGROUND

As is known, in gas transport and/or distribution networks there are provided pressure control stations to reduce the gas pressure from the supply value to the value required by the user, and also keep it stable at the preset value, even in the event of variations in the upstream pressure or in the event of variations in the flow rate required by the user.

In particular, the aforementioned pressure reduction is obtained by means of pressure regulators which are configured to maintain the outlet pressure equal to a preset calibration value, regardless of the gas flow rate delivered.

A known type of pressure regulator comprises a gas passage duct, having an upstream end communicating with the high-pressure branch of the transport and/or distribution network, and the opposite downstream end communicating with the low-pressure branch, which is directed towards the user.

In the gas passage duct, there is a shutter that determines a constriction in the passage section of the duct itself, thus causing a reduction in gas pressure between upstream and downstream of the shutter itself. In particular, the pressure reduction occurs by lamination of the gas at the passage section on which the shutter acts.

Conveniently, the shutter is movable so that the passage section, and therefore the gas pressure drop, can be modified as a function of the flow rate of the gas itself.

The movement of the shutter is controlled by a feedback system which—in the presence of an increase, with respect to the calibration value, of the pressure of the gas supplied downstream (i.e. of the gas downstream of the regulator)—reduces the level of opening of the shutter itself, the opposite occurring in the case of a reduction in pressure.

Depending on the type of control provided, direct-operated pressure control devices and pilot-operated pressure control devices/apparatus are provided. In particular, in direct-operated control devices a single regulator is provided whose level of opening of the shutter—and in particular the level of opening of the section for the passage of gas—is generated by the contrast between the pressure detected downstream (connected to the control head) which pushes on the mobile wall (membrane) of the motorization chamber, and the thrust generated by the calibration spring. In pilot-operated control devices, instead, a main regulator and an additional regulator, called pilot regulator, are provided; in particular, in these devices, the level of opening of the shutter of the main regulator—and in particular of its section for the passage of gas—is controlled/commanded by the pilot regulator which, depending on the compression value of its calibration spring and the actual pressure detected downstream of the device, supplies the main regulator with a command (motorization) pressure adequate to bring the device into equilibrium.

Direct-operated control devices are simpler to construct (in particular, they have fewer components and fewer connections), however, the level of control precision/accuracy is lower than that of pilot-operated control devices. On the other hand, direct-operated control devices have a much higher response speed to downstream load changes. For this reason, their applications are different: direct-operated control devices are mainly used for medium and low-pressure networks (such as civil and industrial distribution networks), with relatively low flow rates and more frequent load variations; pilot-operated control apparatus are instead mostly used for medium and high-pressure networks, where higher flow rates are required and where the variations in the required flow rate are lower and less frequent (such as transport networks).

In direct-operated control devices, on the face F1 of the shutter O facing the downstream zone V and which, in particular, is opposite to the face F2 facing the passage opening A to be throttled and/or closed, over pressurized gas can be generated and accumulated which thus prevents the complete distancing of the shutter from the opening, and therefore the complete opening of the regulator. Undesirably, this leads to a reduction in the maximum flow rate of gas exiting the control device. In particular, it should be considered that a balanced direct-operated pressure regulator is designed so that the set of forces acting on the shutter (both moving away from the opening A and moving towards said opening) is perfectly balanced by the forces acting on the membrane of the balancing chamber CB and the motorization head M. Therefore, an unwanted and unpredictable accumulation of pressure which pushes the shutter of the regulator towards the closing of the opening A leads to a reduction in the maximum flow rate of gas which can be processed by the control device.

Currently, to avoid this, and in particular to balance such overpressures, the known solutions provide for taking the gas that acts on the face F1 of the shutter facing the downstream zone V to bring it to a further dedicated/special balancing chamber CB′. In particular, to this end, from the face F1 of the shutter facing the downstream zone a circuit is obtained (which is defined by one or more ducts/channels obtained inside the shutter support shaft) to fluidly connect the downstream zone V with a dedicated/special balancing chamber CB′ which can be obtained at/in proximity to the balancing chamber CB (on the opposite side of the membrane, see FIG. 2A) or can be obtained at the cover C which closes the downstream zone V of the regulator (and is therefore on the side of the face F1 of the shutter, see FIG. 2B).

These well-known solutions that require the creation of a dedicated/special balancing chamber are rather complex, requiring in particular a series of additional components, and/or rather complex/expensive processing.

### OBJECTS OF THE INVENTION

An object of the invention is to propose a gas regulator, in particular a regulator of the type to be installed in an apparatus for gas pressure control in a gas transport and/or distribution network, which allows to overcome, entirely or partly, the drawbacks of known solutions.

Another object of the invention is to improve the pressure balance at the shutter of a gas regulator, preferably of the direct-operated type.

Another object of the invention is to eliminate or in any case reduce the overpressure at the face of the shutter facing the downstream zone.

Another object of the invention is to propose a regulator that is highly performing, particularly in terms of maximum flow rate and control precision.

Another object of the invention is to propose a regulator that allows for an increase in the maximum flow rate while maintaining the same control precision.

Another object of the invention is to propose a regulator with a reduced number of components and a reduced cost.

Another object of the invention is to propose a regulator that can be obtained in a simple, rapid and low-cost way.

Another object of the invention is to propose a solution that can be installed and used in regulators of various types, possibly even those already available on the market and/or already installed on the field.

Another object of the invention is to propose a solution that can be installed and assembled easily, quickly and at low costs.

Another object of the invention is to propose a regulator that is particularly durable, robust and less subject to wear.

Another object of the invention is to propose a regulator that has a small size, thus facilitating its installation.

Another object of the invention is to propose a regulator that is easy and quick to maintain, as well as inexpensive.

Another object of the invention is to propose a regulator that is in line with the controls in force in the sector.

Another object of the invention is to propose a regulator that is smaller in size, and therefore more compact, than known solutions.

Another object of the invention is to propose a regulator that is highly safe and reliable.

Another object of the invention is to propose a regulator that is an improvement and/or alternative to traditional ones.

Another object of the invention is to propose a regulator that presents an alternative characterization, both in terms of construction and functionality, compared to traditional ones.

Another object of the invention is to propose a method that can be implemented simply, quickly and at low cost to eliminate or in any case reduce the overpressure at the face of the shutter facing the downstream zone.

Another object of the invention is to propose a method for eliminating or in any case reducing the overpressure at the face of the shutter facing the downstream zone which can be implemented in regulators of various types, even those already available on the market and/or already installed on the field.

### SUMMARY

All the objects mentioned herein, considered either individually or in any combination thereof, and others which will result from the following description are achieved, according to the invention, with a regulator as described below and in the appended claims.

### BRIEF DESCRIPTION OF THE DRAWINGS

The present invention is further clarified below in some of its preferred practical embodiments reported for purely exemplifying and non-limiting purposes with reference to the attached tables of drawings, wherein:

FIG. 1 shows a section of a prior art regulator,

FIG. 2A shows a section of another prior art regulator,

FIG. 2B shows a section of a detail of a further regulator according to the prior art,

FIG. 3 shows a perspective view of a regulator according to the present invention,

FIG. 4 shows a section of a detail of the regulator according to the present invention in its fully open condition (i.e, wherein the shutter is in a position of maximum distance from the passage opening),

FIG. 5A shows a section of the same detail as in FIG. 4 in its standard working condition (i.e, wherein the shutter is not in a position of maximum distance from the passage opening),

FIG. 5B shows a perspective view of the section of FIG. 5A,

FIG. 6A shows a top perspective view of element 30 of FIG. 4 (corresponding to a first possible embodiment thereof),

FIG. 6B shows a bottom perspective view of the same element as FIG. 6A,

FIG. 7 shows a section of a detail of the regulator according to the present invention with the element 30 in a second embodiment,

FIG. 8 shows a section of a detail of the regulator according to the present invention with the element 30 in a third embodiment,

FIG. 9 shows a section of a detail of the regulator according to the present invention with the element 300,

FIG. 10A shows a top perspective view of element 300 of FIG. 9, and

FIG. 10B shows a bottom perspective view of the element in FIG. 10A,

FIG. 11 shows a comparative graph of the performance curves between a solution without the 30/300 element and the solution, according to the invention, with the 30/300 element.

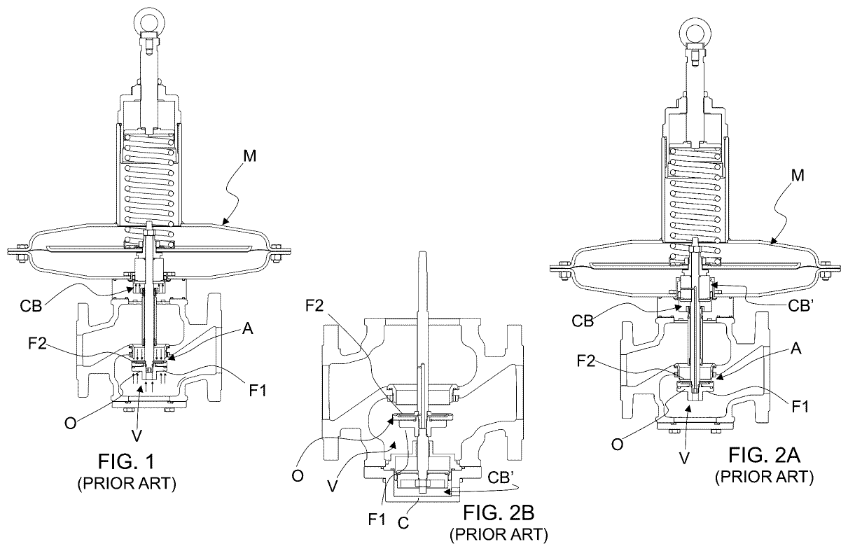

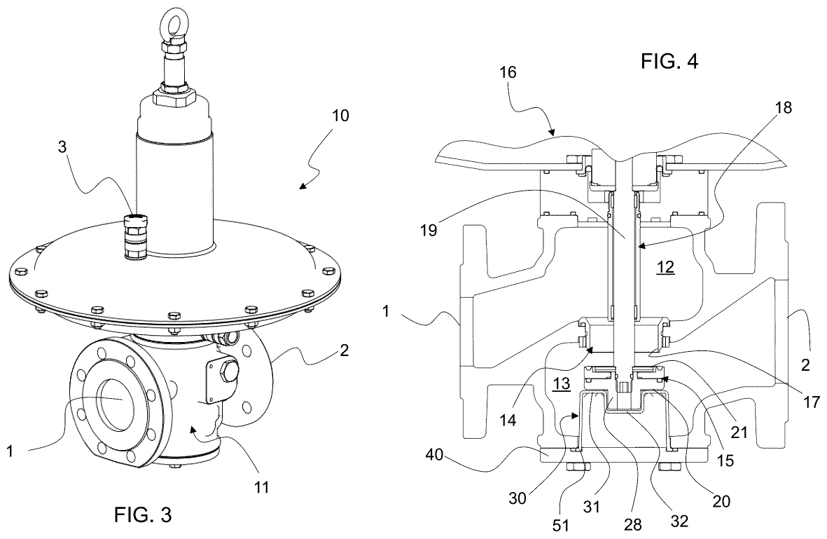

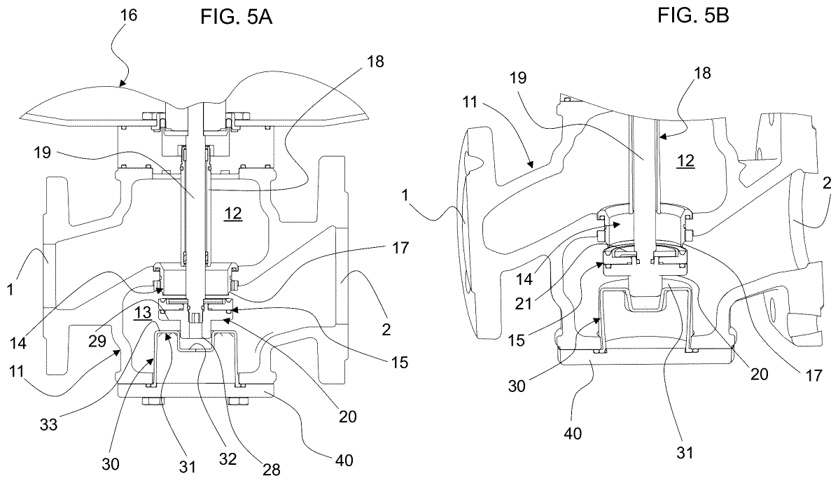

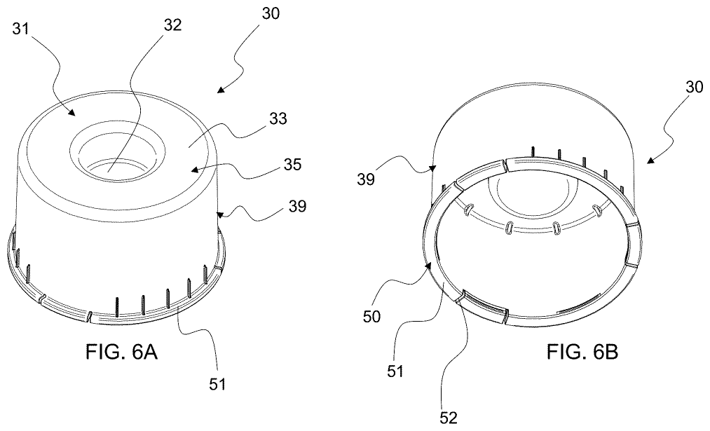

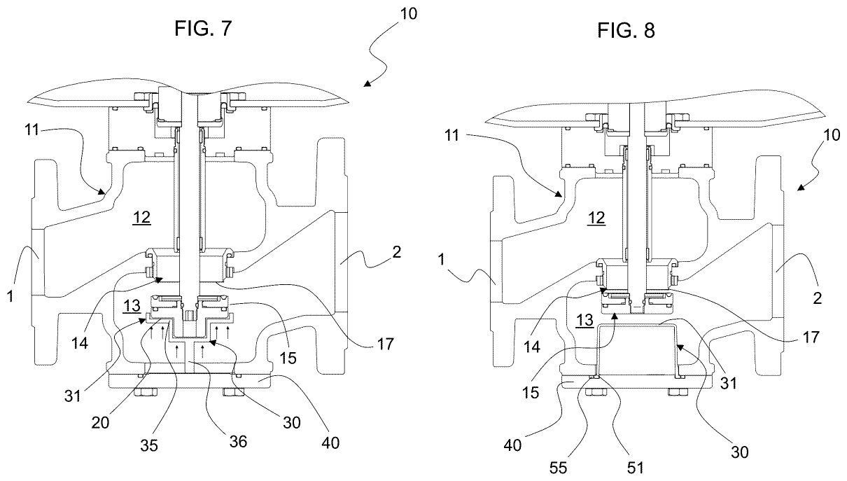

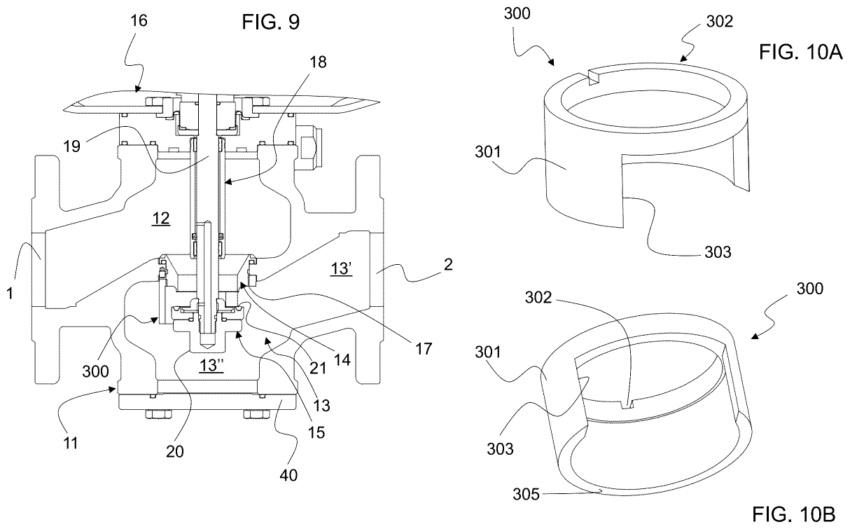

### DETAILED DESCRIPTION OF THE PREFERRED EMBODIMENTS

The headings used herein are for organizational purposes only and are not meant to be used to limit the scope of the description or the claims. As used throughout this application, the words “may” and “can” are used in a permissive sense (i.e., meaning having the potential to), rather than the mandatory sense (i.e., meaning must). Similarly, the words “include,” “including,” and “includes” mean including but not limited to. To facilitate understanding, like reference numerals have been used, where possible, to designate like elements common to the figures.

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

As shown in the figures, the present invention concerns a regulator 10 for a gas control apparatus and, in particular, of the type suitable for installation in a gas transport and/or distribution network, more preferably in a medium and low-pressure gas distribution network.

Preferably, the regulator 10 is suitable for use in the residential distribution sector but could also be used in the industrial sector.

In particular, the control apparatus can be a traditional apparatus (direct or pilot-operated) configured to cause a reduction in the pressure of the gas passing through it, and in particular it is suitable for causing the reduction of the gas pressure from a higher upstream value to a lower downstream pressure value.

Conveniently, the regulator 10 comprises a structure 11, and in particular a containment structure, which can be made in a single piece or, preferably, in several pieces suitably fixed together and comprises within it a plurality of zones, chambers, sub-chambers, cavities and/or passages, as described in greater detail below.

The regulator 10 comprises a gas inlet 1 inside the structure 11 and a gas outlet 2 from the structure 11. Conveniently, the gas inlet 1, the gas outlet 2 and, if provided, at least one passage 3 for the fluid connection with the environment wherein the regulator itself is intended to be installed, are obtained on the structure 11.

Preferably, corresponding fittings are provided on the structure 11, at the gas inlet 1 and the gas outlet 2, for the connection with a section of upstream pipe and with a section of downstream pipe respectively.

Within the structure 11, the regulator 10 comprises:
an upstream zone 12 which is in fluid connection with the inlet 1,
a downstream zone 13 which is in fluid connection with the outlet 2,
a passage opening 14 which is interposed between the upstream zone 12 and the downstream zone 13,
a shutter 15 which is movable for closing and/or obstructing the passage opening 14,
means 16 for the controlled movement of the mobile shutter 15.

The means 16 for the controlled movement of the mobile shutter 15 are preferably of a traditional type and, as such, will not be described in detail below. In particular, the means 16 may comprise a control head (not shown) with a mobile unit 18 which is mechanically connected or integral with the shutter 15. Conveniently, the control head can comprise a chamber wherein a dividing element is housed which is mobile and which divides the chamber itself into a first sub-chamber and a second sub-chamber. Conveniently, the gas at a given pressure, for example the downstream pressure exiting the regulator, and thrust means, for example defined by a helical spring interposed between the dividing element and a fixed element, may act in opposite directions on the mobile dividing element. Preferably, the mobile unit 18 comprises a shaft 19 on which the shutter 15 is mounted/fixed.

Preferably, the means 16 for the controlled movement of the mobile shutter 15 comprises a mobile unit 18 that, at least in part, passes through the upstream zone 12. More preferably, the mobile unit 18 comprises a shaft 19, on which the shutter 15 is mounted/fixed, and wherein said shaft 19 passes through the upstream zone 12 and is movable within the upstream zone 12.

Preferably, in the possible embodiment illustrated in the figures, the passage opening 14 is defined in the fluid path of the gas between the upstream zone 12 and the downstream zone 13.

Conveniently, the gas in the upstream zone 12 of the regulator 10 is at the pressure Pm which corresponds to the gas pressure at the inlet to the regulator 10, and therefore to the gas pressure upstream of the regulator itself.

Conveniently, the shutter 15 is movable with respect to the passage opening 14 to vary the obstruction of the passage opening 14 of the gas from the upstream zone 12 to the downstream zone 13, thus causing a corresponding reduction in pressure of the gas which passes from said upstream zone 12 to said downstream zone 13 through the passage opening itself.

Therefore, the gas in the downstream zone 13 is at a Pu that is lower/reduced compared to the pressure Pm of the upstream zone 12. Conveniently, since the downstream zone 13 is fluidically connected directly to the outlet 2, the gas exiting the regulator 10 is at a pressure Pu.

The shutter 15 is movable within the downstream zone 13 and, in particular, is movable towards and away from the mouth 17 of the passage opening 14 which faces the downstream zone 13.

The shutter 15 comprises a first face 20 which faces the downstream zone 13 and a second face 21 (which is opposite to the first face 20) which faces the passage opening 14 and, in particular, faces the mouth 17 of the passage opening 14 which faces the downstream zone 13.

Preferably, the downstream zone 13 is positioned, at least in part, lower (i.e. below) than the upstream zone 12.

The regulator 10 according to the present invention comprises an element 30 which is positioned within the downstream zone 13 in a position facing the shutter 15 and which is configured to cooperate with the first face 20 of the shutter which faces the downstream zone so as to divert the gas flow at said first face 20 of the shutter, and thus reduce the gas pressure which acts directly on said first face 20 of the shutter which faces the downstream zone.

Conveniently, said element 30 comprises at least a portion 31 which faces the shutter 15 and which is configured and intended to cooperate with the first face 20.

Conveniently, said element 30 is positioned inside the downstream zone 13 and is configured so as to receive in support (i.e. substantially with contact) the first face 20 of the shutter 15 or in any case so as to be in proximity (i.e. even without contact, therefore leaving a certain passage/play) of the first face 20 of the shutter only when said shutter is in the position of maximum distance from the passage opening 14, a position which corresponds to the condition of maximum opening of the regulator 10.

Conveniently, the gas between the element 30 and the first face 20 of the shutter 15, and in particular the gas between the portion 31 and the first face 20, is in direct fluid communication with the surrounding gas present in the downstream zone 13, as long as the first face does not come into contact with the element 30, and preferably with its portion 31.

Preferably, there is no sealed volume defined by the element 30 and the shutter 15 when, at least in part, they come into contact, except for some negligible volumes originating from small mechanical play(s) between the said element and said shutter.

Conveniently, the element 30 does not act as guide element for the shutter 15.

Preferably, said element 30 is configured, in particular in terms of the shape of its portion 31 and/or in terms of its size/height (thus determining the gas passage space between its portion 31 and the first face 20 of the shutter 15), so as to receive in support (i.e. substantially with contact) the first face 20 of the shutter 15 or in any case so as to be in proximity (i.e. even without contact, therefore leaving a certain passage/play) of the first face 20 of the shutter only when said shutter is in the position of maximum distance from the passage opening 14, a position which corresponds to the condition of maximum opening of the regulator 10.

Conveniently, said element 30 is positioned inside the downstream zone 13 and is configured so as not to interfere or in any case to interfere in a minimal (or substantially irrelevant) way with the first face 20 of the shutter 15 when, in normal operating conditions of the regulator, the shutter itself (and in particular when its second face 21) cooperates with the mouth 17 of the passage opening 14 to cause the reduction of the gas that passes through said opening to pass from the upstream zone 12 to the downstream zone 13.

Preferably, the portion 31 of the element 30 has a shape corresponding or complementary to the first face 20 of the shutter 15 facing the downstream zone.

Ideally, the portion 31 of the element 30 has a shape corresponding or complementary to the first face 20 of the shutter 15 facing the downstream zone so that, when the first face 20 of the shutter 15 substantially rests on or is close to the portion 31, there is substantially minimal leakage, except for a limited play, between said first face 20 and said portion 31.

Preferably, the portion 31 of the element 30 comprises at least one section or profile shaped to cooperate, ideally by contact/support (even partially), with a counter-shaped section or profile of the first face 20 of the shutter 15.

In a possible embodiment, the first face 20 of the shutter 15 comprises a protruding portion 28 surrounded by an annular portion 29 which is substantially flat. Correspondingly, the portion 31 of said element 30 comprises a central depressed portion 32 for the insertion of the protruding portion 28 of the shutter 15 and a further annular portion 33, also substantially flat, to receive the annular portion 29 of the shutter 15 in support.

In another possible embodiment (see FIG. 8), the first face 20 of the shutter 15 may be entirely flat or substantially flat and, correspondingly, the portion 31 of the element 30 is also entirely flat or substantially flat.

Preferably, the entire or most of the surface area of the portion 31 of the element 30 cooperates with the entire or most of the surface area of the first face 20 of the shutter 15. Advantageously, in this way, overpressures are completely prevented on the first face of the shutter.

Preferably, said element 30 can be made in a single piece, but it could be made in several pieces fixed together.

Preferably, said element 30 can be made of various materials, for example it can be made of polymeric material (plastic), metal or composite materials.

Preferably, said element 30 can be shaped like a cap or bell or like an inverted glass.

Preferably, in a possible embodiment, said element 30 comprises a body 39 having a substantially cylindrical or frustoconical shape and with a base 35 which defines the portion 31 of cooperation with the first face 20 of the shutter that faces the downstream zone. Preferably, the other base of the element (i.e. the bottom of the body 39 having a cylindrical or frustoconical shape) can be open. Preferably, the element 30 can comprise a body 39 having a cylindrical or frustoconical shape that is hollow internally and has passages 52 to allow gas to enter inside the body 39; in particular, in the case of an internally hollow body 39, the inside of the body 39 is not sealed and this is in order to allow the circulation of gas between the inside and outside of the body 39, thus avoiding an unwanted accumulation of gas inside the body 39.

Preferably, in a possible embodiment, the element 30 can comprise a base 35, which defines the portion 31 of cooperation with the first face 20 of the shutter, which is supported by a central support stem 36.

Preferably, said element 30 can be mounted on a cover 40 of the structure 11. Ideally, the cover 40 is removable from the structure 11 and, for example, can be removably associated with the remaining part of the structure 11 by means of traditional fastening members (such as screws or bolts). In particular, the removable cover 40 internally delimits, at least in part, the downstream zone 13. More preferably, the removable cover 40 faces the shutter 15 or in any case is arranged in such a way that its removal from the remaining part of the structure 11 allows access to the shutter 15.

Preferably, in one possible embodiment, the element 30 can be fixed/constrained to the inner face of the removable cover 40.

Preferably, in one possible embodiment, the element 30 can be removably mounted/associated with the inner face of the removable cover 40.

Preferably, said element 30 comprises, in a position opposite the portion 31 configured to cooperate with the first face 20 of the shutter, mounting means 50 configured for mounting the element 30 on the structure 11, more preferably at the cover 40 of the structure 11 which is removable from the remaining part of the structure 11.

Preferably, in a possible embodiment, the mounting means 50 of the element 30 are configured for interlocking, snap-fit or form-fit engagement on the cover 40. Preferably, the element 30 is first mounted/associated with the cover 40 and it is then the latter, with the element 30 already/thus mounted/associated, which is associated with the remaining part of the structure 11; advantageously this allows the installation, as well as maintenance, of the element 30 to be speeded up and simplified.

Preferably, in a possible embodiment, the mounting means 50 of the element 30 comprise a flanged edge 51 which is opposed to the base 35 defining the portion 31. Conveniently, the flanged edge 51 can be configured to be clamped between the cover 40 and the remaining part of the structure 11 to which the cover is removably associated. Conveniently, the flanged edge 51 can be configured to engage, for example by snapping, within a groove obtained on the internal face of the cover 40, possibly with the addition of an annular gasket 55 (for example an O-ring).

The element 30 therefore occupies the free volume of the downstream zone 13 which faces the shutter 15 and diverts the flow of gas which has passed through the opening 14, preventing or in any case reducing the passage of such gas flow at said first face 20 of the shutter and therefore preventing or in any case reducing the formation of overpressures which would otherwise act on said first face 20 of the shutter, pushing it towards the closure of the passage opening 14.

Advantageously, the solution according to the invention allows to avoid or in any case reduce the concentration of unwanted gas overpressures on the face 20 of the shutter facing the downstream zone 13, forming an accumulation of pressure of a value greater than the calibration pressure of the regulator and pushing the shutter itself towards the passage opening 14, thus preventing the complete and maximum distancing of the shutter from said opening and therefore the regulator from reaching the maximum opening condition. In essence, advantageously, the position and configuration of said element 30 avoid or in any case reduce the concentration/accumulation of the aforementioned overpressures on the face 20 of the shutter facing the downstream zone, thus allowing the complete and maximum distancing of the shutter from the passage opening 14; in particular, this allows the regulator 10 to be able to reach and operate in the maximum opening condition, and therefore without reductions in the maximum gas flow rate that can be delivered by the regulator itself.

Advantageously, based on the characteristics of the element 30, in particular in terms of the shape of the portion 31 and the longitudinal development of the element itself, it is possible to vary the flow of gas that passes between the portion 31 and the first face 20 of the shutter 15, thus contributing to vary/define the characteristic control (or performance) curve of the regulator itself.

The present invention concerns an element 300 which is positioned within the downstream zone 13 at the mouth 17 of the passage opening 14 which faces the downstream zone 13 and is configured to cooperate with the second face 21 of said shutter 15 which faces said mouth 17 to divert the flow of gas exiting from said mouth 17 towards a first part 13′ of the downstream zone 13 which is closer to the outlet 2 than a second part 13″ of said downstream zone 13, thereby reducing the gas pressure which in said second part 13″ of the downstream zone acts on said first face 20 of the shutter 15.

Conveniently, the downstream zone 13 comprises a first part 13′ and a second part 13″ where the first part is closer to the outlet 2 than the second part 13″. Conveniently, the first face 20 of the shutter 15 faces the second part 13″ of the downstream zone 13. Preferably, the first part 13′ is substantially arranged laterally to the direction of movement of the shutter 15 with respect to the opening 14, while the second part 13″ is substantially arranged below the shutter 15, resulting in being substantially aligned with the direction of movement of the shutter itself.

Advantageously, the gas flow exiting from the mouth 17 is diverted directly to the outlet 2, thus reducing the accumulation of gas on the first face 20 of the shutter.

Preferably, the element 300 comprises a tubular body 301 which, at one end, is provided with means 302 for its mounting in a hung condition on the mouth 17 and which is provided on its side wall with an open or missing portion 303 which-once the element has been mounted on said mouth—is intended to be open and facing said first part 13′ of the downstream zone 13, i.e. towards the part of the downstream zone which faces the outlet 2.

Preferably, the tubular body 301 is provided with a single open or missing portion 303. Alternatively, the tubular body may be provided with several open or missing portions 303 which all face said first part 13′ of the downstream zone 13, to thus divert the flow—in cooperation with the second face 21 of the shutter 15—towards the same first part.

More preferably, said means 302 for mounting the element 300 on the mouth 17 may comprise elastic hooking means and/or means for interlocking or shape-relation engagement. More preferably, said means 302 for mounting the element 30 on the mouth 17 are configured to hang the element 30 at the mouth 17.

Preferably, the tubular body 301 of said element 300, is configured (in particular in terms of its longitudinal development) so that the other end 305, which is opposite to the end mounted on the mouth 17, is located inside the downstream zone 13 at a height that is substantially flush with the second face 21 or in any case is interposed between the first face 20 and the second face 21 of the shutter 15 when the latter is in the position of maximum distance from the passage opening 14, a position which corresponds to the maximum opening condition of the regulator 10.

Preferably, the cross-section of the tubular body 301 of said element 300 is configured, in terms of shape and size, so as to be slightly larger than that of the shutter 15.

The present invention also relates to a method for reducing the gas pressure on the first face 20 of the shutter 15 which faces the downstream zone 13 of the regulator itself, and wherein an element 30 or 300 is used as described above and positioned/mounted inside the downstream zone 13. In particular, the element 30 can be mounted on the structure 11 and, in particular on the removable cover 40 of said structure 11, in a position facing the shutter 15. In particular, the element 300 can be mounted, and preferably hung, at the mouth 17 of the passage opening 14.

The present solution with element 30 can be used in direct-operated regulators, in main regulators used in a pilot-operated apparatus, or in general in all regulators where a pressure accumulation could be generated at the face of the shutter facing the downstream zone.

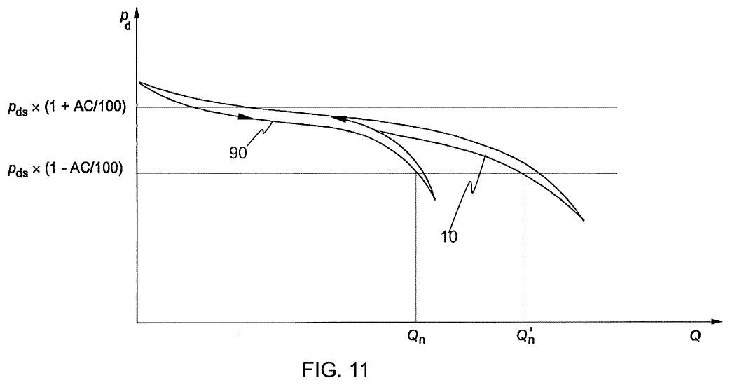

Advantageously, as shown in FIG. 11, from the characteristic curves (detected and processed according to the provisions of the European reference standard EN334-2019, or other corresponding reference standards such as for example the Chinese standard GB27790-2020) of the regulator according to the invention 10, which is provided with an element 30 or 300, and of the regulator 90, which is instead without an element 30 or 300, it results that within the accuracy class AC the regulator 10 according to the invention reaches a flow rate Qn′ which is greater than the one achieved by the regulator 90. In essence, given an accuracy class AC, the regulator 10 according to the invention allows for the control of a greater flow rate.

From what has been said it is clear that the solution according to the invention is advantageous as it allows to achieve the above-mentioned objects and in particular:
it allows to eliminate or in any case reduce the gas overpressure acting on the face of the shutter facing the downstream zone,
it improves the performance of the regulator, in particular it allows to increase the flow rate while maintaining a high precision of pressure control,
it is simple to make and install/assemble in various types of regulators even those already on the market and/or installed on the field; in particular, it is not necessary to act on the motorization head or on the mobile group, but it is sufficient to remove the cover that delimits the exit zone,
by varying the shape of element 30 or 300 it is possible to optimize the performance of the regulator.

The present invention has been illustrated and described in a preferred embodiment, but it is understood that executive variations may be made to it in practice, without however departing from the scope of protection of the present patent for industrial invention.

1. Regulator (10) for a gas control apparatus, for installation in a gas transportation and/or distribution network, the regulator comprising a structure (11) with a gas inlet (1) and a gas outlet (2),
wherein, inside the structure (11), the regulator (10) comprises:
an upstream zone (12) that is fluidly connected to the inlet (1),
a downstream zone (13) that is fluidly connected to the outlet (2),
a passage opening (14) interposed between the upstream zone (12) and the downstream zone (13),
a shutter (15) movable within the downstream zone (13) for closing and/or obstructing the passage opening (14), said shutter (15) comprises a first face (20) facing towards the downstream zone (13) and a second face (21), opposite to the first face (20), facing towards the passage opening (14),
means (16) for the controlled movement of the movable shutter,
wherein said regulator comprises an element (30) positioned within the downstream zone (13), facing the shutter (15), and including a portion (31) configured to cooperate with the first face (20) of the shutter facing towards the downstream zone so as to divert the gas flow at said first face (20) of the shutter, thus reducing the gas pressure acting directly on said first face (20) of the shutter facing towards the downstream zone (13).

2. The regulator according to claim 1, wherein said element (30) is positioned within the downstream zone (13) and is configured to contact the first face (20) of the shutter (15) or to be in proximity of the first face (20) of the shutter only when said shutter is in a position of maximum distance from the passage opening (14).

3. The regulator according to claim 1, wherein the portion (31) of the element (30) comprises at least one shaped section or profile to cooperate with a correspondingly shaped section or profile of the first face (20) of the shutter (15).

4. The regulator according to claim 1, wherein said portion (31) of the element (30) has a shape corresponding or complementary to the first face (20) of the shutter (15) facing the downstream zone.

5. The regulator according to claim 1, wherein the first face (20) of the shutter (15) is entirely flat or substantially flat and, correspondingly, said portion (31) of the element (30) is also entirely flat or substantially flat.

6. The regulator according to claim 1, wherein the means (16) for the controlled movement of the mobile shutter (15) comprises a mobile unit (18); the mobile unit (18) comprises a shaft (19), on which the shutter (15) is mounted/fixed; and said shaft (19) passes through the upstream zone (12) and is movable within the upstream zone (12).

7. The regulator according to claim 1, wherein said element (30) comprises an internally hollow body (39), substantially cylindrical or frustoconical in shape, with a base (35) defining the portion (31) for cooperation with the first face (20) of the shutter facing towards the downstream zone.

8. The regulator according to claim 7, wherein the hollow body (39) has passages (52) to allow gas to enter inside the body (39).

9. The regulator according to claim 1, wherein the element (30) comprises a base (35), defining the portion (31) for cooperation with the first face (20) of the shutter, and is supported by a central support stem (36).

10. The regulator according to claim 1, wherein the element (30) is mounted on a removable cover (40) of the structure (11).

11. The regulator according to claim 10, wherein the removable cover (40) is arranged in such a way that its removal from the remaining part of the structure (11) allows access to the element (30) and to the shutter (15).

12. The regulator according to claim 1, wherein the entire or most of the surface area of the portion (31) of the element (30) cooperates with the entire or most of the surface area of the first face (20) of the shutter (15).

13. The regulator according to claim 1, wherein said element (30) comprises, in a position opposite to the portion (31) configured to cooperate with the first face (20) of the shutter, mounting means (50) configured removably mount the element (30) on the structure (11).

14. The regulator according to claim 13, wherein said mounting means (50) of the element (30) are configured to cooperate with a removable cover (40) of the structure (11).

15. Regulator (10) for a gas control apparatus, for installation in a gas transportation and/or distribution network, the regulator comprising a structure (11) with a gas inlet (1) and a gas outlet (2), wherein, inside the structure (11), the regulator (10) comprises:
an upstream zone (12) that is fluidly connected to the inlet (1),
a downstream zone (13) that is fluidly connected to the outlet (2), said downstream zone (13) comprises a first part (13′) and a second part (13″), wherein the first part is closer to the outlet (2) than the second part (13″),
a passage opening (14), having a mouth (17), interposed between the upstream zone (12) and the downstream zone (13),
a shutter (15) movable for closing and/or obstructing the passage opening (14), said shutter (15) comprises a first face (20) facing towards the second part (13″) of the downstream zone (13) and a second face (21), opposite to the first face (20), facing towards the passage opening (14),
means (16) for the controlled movement of the movable shutter (15),
wherein said regulator comprises an element (300) positioned within the downstream zone (13) at the mouth (17) of the passage opening (14) facing towards the downstream zone (13) and is configured to cooperate with the second face (21) of said shutter (15) facing towards said mouth (17) to divert the gas flow exiting from said mouth (17) towards said first part (13′) of the downstream zone (13) that is closer to the outlet (2), thereby reducing the gas pressure acting on said first face (20) of the shutter (15) in said second part (13″) of the downstream zone.

16. The regulator according to claim 15, wherein the element (300) comprises a tubular body (301) which, at one end, is provided with means (302) for mounting the tubular body (301) in a hung condition on said mouth (17) and is provided on a side wall thereof with an open or missing portion (303) that is open and facing towards said first part (13′) of the downstream zone (13).

17. The regulator according to claim 16, wherein the tubular body (301) of said element (300) is configured so that an end (305), which is opposite to the end mounted on the mouth (17), is located inside the downstream zone (13) at a height that is substantially flush with the second face (21) or is interposed between the first face (20) and the second face (21) of the shutter (15) when the shutter (15) is in a position of maximum distance from the passage opening (14).

18. The regulator according to claim 16, wherein the cross-section of the tubular body (301) of said element (300) is configured, in terms of shape and size, so as to be slightly larger than that of the shutter (15).

19. The regulator according to claim 16, wherein the tubular body (301) is provided with a single open or missing portion (303) that is open and facing towards said first part (13′) of the downstream zone (13).

20. Method for reducing the gas pressure acting on a first face (20) of a shutter (15) of a regulator (10) for a gas control apparatus, of the type suitable for installation in a gas transportation and/or distribution network, said regulator comprising a structure (11) with a gas inlet (1) and a gas outlet (2), and wherein, inside the structure (11), the regulator (10) comprises:
an upstream zone (12) that is fluidly connected to the inlet (1),
a downstream zone (13) that is fluidly connected to the outlet (2),
a passage opening (14) interposed between the upstream zone (12) and the downstream zone (13),
said shutter (15) movable within the downstream zone (13) for closing and/or obstructing the passage opening (14), said shutter (15) comprising said first face (20) facing towards the downstream zone (13) and a second face (21), opposite to the first face (20), facing towards the passage opening (14),
means (16) for the controlled movement of the movable shutter (15),
the method comprising:
using an element (30) positioned within the downstream zone (13) facing the shutter (15), said element (30) comprising a portion (31) configured to cooperate with the first face (20) of the shutter facing towards the downstream zone to divert the gas flow at said first face (20) of the shutter, thereby reducing the gas pressure acting directly on said first face (20) of the shutter facing towards the downstream zone, or
using an element (300) positioned inside the downstream zone (13) at a mouth (17) of the passage opening (14) facing towards the downstream zone (13), said element (300) being configured to cooperate with the second face (21) of said shutter (15) facing towards said mouth (17) to divert the gas flow exiting from said mouth (17) towards a first part (13′) of said downstream zone (13) that is closer to the outlet (2) than a second part (13″) of said downstream zone (13), thereby reducing the pressure of the gas, in said second part (13″) of the downstream zone, that acts on said first face (20) of the shutter (15).
